(19) United States
(12) Patent Application Publication
(10) Pub. No.: US 2014/0043750 A1
(43) Pub. Date: Feb. 13, 2014

(54) Laptop Computer Cooling and Docking Station

(71) Applicants: Philip Calderone, Painesville, OH (US); Michael Onion, Chesterland, OH (US)

(72) Inventors: Philip Calderone, Painesville, OH (US); Michael Onion, Chesterland, OH (US)

(21) Appl. No.: 13/940,418

(22) Filed: Jul. 12, 2013

Related U.S. Application Data
(60) Provisional application No. 61/681,946, filed on Aug. 10, 2012.

(51) Int. Cl. G06F 1/20

(52) U.S. Cl. CPC G06F 1/203
USPC 361/679.41

(57) ABSTRACT

A laptop computer docking station and cooling device is provided. The device comprises a first cooling platform having an upper surface to support the base of a laptop computer and a plurality of airflow apertures therealong. Within the platform are several high efficiency electric fans that draw heat from the laptop through the airflow apertures and expel the same from the lateral sides of the cooling platform. Attached to the rear of the cooling platform is a docking station housing supporting a plurality of electrical ports for peripheral devices and an internal electrical board for processing signals between an attached laptop computer and the ports. The cooling platform further supports a SCSI port connection for the laptop, which is adapted to connect to the laptop and allow the computer to connect to peripheral devices while being cooled, thereby combining the qualities of a computer cooling station with a docking station.

### CROSS REFERENCE TO RELATED APPLICATION

This application claims the benefit of U.S. Provisional Application No. 61/681,946 filed on Aug. 10, 2012, entitled “Cool Dock.” The above identified patent application is herein incorporated by reference in its entirety to provide continuity of disclosure.

### BACKGROUND OF THE INVENTION

### FIELD OF THE INVENTION

The present invention relates to laptop computers, computer docking stations, and computer cooling pads. More specifically, the present invention pertains to a new and novel docking station having an air cooling means that draws in ambient air and expels heated air from the laptop computer, while providing connection interfaces for computer peripherals.

Modern laptop computers have ever increasing capabilities as technology advances, wherein the gap between personal computers and mobile laptops has shortened. A majority of users utilize laptop computers for personal computing, wherein the device is utilized for personal use and not for work or productivity purposes. Other laptop users include those that employ them for work purposes as a dedicated productivity tool, wherein work operations including data processing, networking, and communication are facilitated through a laptop workstation computer. Still other laptop users include gamers and power users, who utilize laptop computers having vast computing capacity and increased capabilities over most commonly deployed laptops for computer gaming and computer programming.

Laptop computers for productivity users and high end users are generally utilized in connection with a docking station for increased peripheral connectivity and for improved ergonomics while the user is engaging the laptop. A dedicated docking station for the laptop increases the user's ability to operate the device as a standard work station, while also allowing the user to remove the laptop and travel therewith when required. Docking stations and modern, high powered laptops therefore offer the best of both worlds: extensive computing power and mobility.

High end users and productivity users require laptops with greater computing power to fulfill their needs. With this increased computing power comes increased heat generation from the laptop as the device cycles through millions of operations per second and operates using the most modern, sophisticated hardware often running at high capacity. Commensurate with the increased power of these more powerful laptop computers is an associated increase in heat generation, which needs to be exhausted from the device to prevent overheating, automated shut-downs triggers, and even permanent damage to the hardware caused by the extreme heat and exposure thereto.

Devices commonly used for expanding the capability of laptops are docking stations, which connect to the laptop and provide more ports for accessory and peripheral items, while also providing support for external displays and keyboards. These devices, however, are not generally suited for providing a cooling means or heat exhausting means from the laptop computer, and are more directed to expanding the connectivity of the device to several peripherals using a single connection.

Laptop cooling pads are devices that the generally used with laptops for the purposes of allowing heat to escape therefrom or for actively cooling the device through convention or conduction. Many of these pads are wholly ineffective for higher output laptops, while others are directed to use with specific laptop brands or models. These cooling pads are further not suited for the increased connectivity provided by a docking station. Therefore, what is desired is a high output laptop cooling device that combines its cooling features with the connectivity of a laptop docking station, whereby two functions are facilitated with a single device.

The present invention provides a new a novel laptop cooling and docking station, whereby the laptop is connected by way of its Small Computer System Interface (SCSI) to allow for connectivity of peripherals to the laptop without direction connection thereto, while the fan structure includes a means of drawing in ambient air exhausting heat from the laptop position thereover. The assembly offers an electrically connected cooling and docking station that efficiently cools high output laptops, while also allowing the user to operate the device as if it were a dedicated workstation or personal computer with associated peripherals.

### DESCRIPTION OF THE PRIOR ART

Devices have been disclosed in the prior art that relate to laptop cooling devices and docking stations. These include devices that have been patented and published in patent application publications, and generally relate to brand and model specific cooling devices or those having diverging elements with respect to the present invention. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 6,574,102 to Usui discloses a docking station having a fan unit attached to the unit and an air suction opening for drawing in heat from an attached computer and dissipating it into the environment. The docking station is model specific in that it draws in air from a port adapted to be located below a specific computer's heat sink and exhaust fan. The present invention provides a platform having vents coextensively along its upper surface for the device to sit upon, wherein internal fans below the vented surface remove heat from the connected device. The hottest points of a connected laptop are generally the hard drive area, the computer processor, the video chip area, and the optical drive area. The present invention addresses these regions of high heat generation by uniformly drawing in heated air through the device upper surface, making the assembly suitable for any laptop design configuration

U.S. Pat. No. 6,084,769 to Moore describes a docking station with auxiliary heat dissipation system for a portable computer. The device is a manufacturer laptop-specific device that utilizes a thermal plug that is received by the docked computer. The device can only be used with a computer that is designed to receive a specific thermal plug. While providing a means of cooling a docked computer, the Moore device is limited in its application to different model laptops. The present invention is designed to accommodate most any sized laptop and provide a SCSI port connection along the upper surface thereof for connectivity of the laptop to peripherals while being cooled. No special ports or plugs needed to connect a laptop to the present invention for cooling.

U.S. Pat. Nos. 6,845,008 and 6,837,057 to Pokharna disclose a docking station for cooling a notebook computer that utilizes apertures in the docking station that are adapted to align with apertures on the connected device. Exhaust fans are further provided in the docking station to exhaust air out of the back of the docking station from the laptop device. The present invention comprises exhaust fans directly under the connected device for removing the hot air at the point of creation. The air is removed through vents along the sides of the cooling platform rather than along the back of the docking station where the peripheral devices may be connected and require space for electrical connections. By drawing air from the laptop device, the present invention removes the heat more efficiently than cooling stations that force air into the laptop for cooling purposes. The present invention also does not require the laptop to include apertures aligned with the docking station for efficient cooling, as fans are dispersed about the cooling platform.

U.S. Pat. No. 6,181,553 to Bhatia discloses an airflow heat exchanger for a laptop computer docking station. The device includes a heat exchange duct that thermally couples to the processor of the attached computer device. A forced air fan draws heat from the processor when the duct is coupled thereto. While an effective heat dissipation device, the Bhatia device fails for a similar reason as the Moore device, wherein the device is exclusive to a specific style of computer design. The Bhatia device is only suited for use with a connecting device that is designed to receive the heat ducts. The present invention, by contrast, provides a cooling function for any laptop device, while those with a SCSI port connection are afforded electrical connectivity for peripheral usage. No special ports or plugs are necessary to connect a laptop for cooling.

Finally, U.S. Pat. No. 5,959,836 to Cipolla discloses a portable computer docking station and heat exchanger having thermal plugs to transfer heat directly from the heat producing elements of the computer to the docking station for dissipation. A thermal plug and socket connect the laptop to the docking station, through which heat is conducted for cooling of the computer circuit board and processor. The present invention does not require such a connection, and is operable with any type of laptop base. No firm contact to any special parts of the cooling platform is necessary to properly cool the connected device.

The present invention provides a docking station that expands the laptop computer peripheral ports and increases its connectivity, while at the same time providing a platform to draw heat from the laptop and cool it during operation. The device is ideally suited for use transforming a laptop into a more dedicated workstation or desktop, where peripheral items such as external monitors, hard drives, keyboards, and other items can be connected through the docking station when the computer is connected. While connected, the laptop computer is actively cooled by way of an airflow generated by internal fans within the docking station cooling platform, upon which the laptop rests and is connected through a Small Computer System Interface, or SCSI connection.

The present invention can be designed for general use or for specific brands of laptop hardware, wherein the docking station provides for expanded laptop capability and ensured operations through temperature regulation. It is submitted that the present invention is substantially divergent in design elements from the prior art, and consequently it is clear that there is a need in the art for an improvement to existing laptop cooling and docking station devices. In this regard the instant invention substantially fulfills these needs.

### SUMMARY OF THE INVENTION

In view of the foregoing disadvantages inherent in the known types of laptop cooling and docking stations now present in the prior art, the present invention provides a new laptop connectivity device that can be utilized for providing convenience for the user when expanding the peripheral connectivity of a laptop computer for use as a more dedicated workstation, while maintaining a cool working temperature therefor while in operation.

It is therefore an object of the present invention to provide a new and improved laptop cooling and docking station device that has all of the advantages of the prior art and none of the disadvantages.

It is another object of the present invention to provide a laptop cooling and docking station the provides a cooling platform and a laptop peripheral expansion dock for combining qualities of a cooling station with a laptop docking station.

Another object of the present invention is to provide a laptop cooling and docking station that includes a SCSI port connection for generic connection to a laptop computer.

Yet another object of the present invention is to provide a laptop cooling and docking station that is adapted to draw hot air from a laptop computer without using specific thermal connections, conduits, or plug locations, whereby the cooling platform provides a cooling function for any type of laptop placed thereon.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an overhead perspective view of the present invention, where the cooling platform is shown in broken lines to highlight the cooling fans therein.

FIG. 2 shows an overhead view of the present invention.

FIG. 3 shows a perspective view of the present invention with a laptop computer attached thereto and shown in broken lines.

FIG. 4 shows a view of the device in a working state.

### DETAILED DESCRIPTION OF THE INVENTION

Reference is made herein to the attached drawings. Like reference numerals are used throughout the drawings to depict like or similar elements of the laptop cooling and docking station. For the purposes of presenting a brief and clear description of the present invention, the preferred embodiment will be discussed as used for expanding a laptop peripheral connection capability while maintaining a cool temperature therefor when in operation. The figures are intended for representative purposes only and should not be considered to be limiting in any respect.

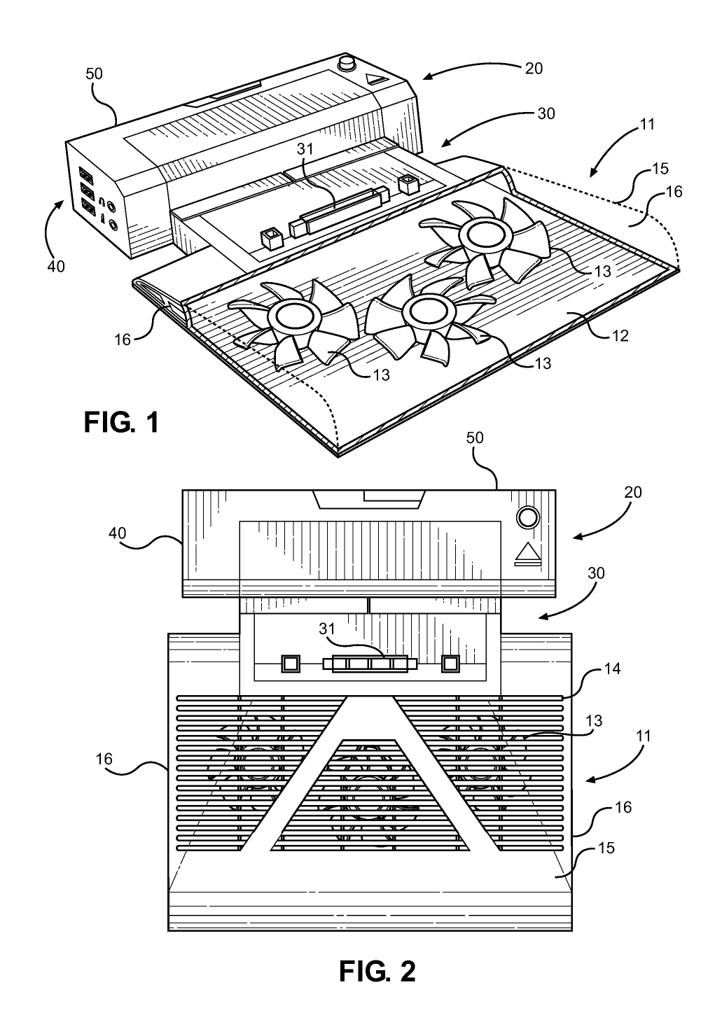

Referring now to FIG. 1, there is shown a perspective view of the laptop cooling and docking station of the present invention. The device comprises a cooling platform 11, a docking station peripheral housing 20, and a bridge 30 therebetween. The cooling platform 11 comprises a substantially rectangular structure having an upper surface 15, an interior volume 12, and upstanding sidewalls 16 that create a housing upon which a laptop computer is adapted to be placed. The upper surface 15 comprises a plurality of elongated apertures through which heated air from the laptop computer is drawn by at least one electrical fan 13. The fans 13 are high efficiency, low noise air flow means that draw heated air away from the laptop and expel the same through apertures in the sidewalls 16 of the housing. This creates airflow over the laptop motherboard and processor by way of convection, which aides in removal of heat and prevents stifling hot air from overheating the laptop computer.

Connecting the cooling platform 11 with the docking station 20 is a bridge 30, which supports the rear of the laptop and includes an electrical interface connection 31 adapted to connect therewith. Preferably, a SCSI electrical connector 31 is provided for optionally connecting a compatible laptop computer thereto, whereby electrical connectivity is achieved with the peripheral ports within the rear docking station 30. The device can also be configured to monitor the laptop fan and control the operation of the cooling fans 13 within the cooling platform 11, whereby the laptop fans and the cooling fans 13 would operate on the same schedule to preserve energy.

Once connected, the laptop is provided access to the docking station 20 ports, which act as an expansion of ports for peripheral items and provides direct connection of the laptop operation (power button, etc.) through the docking station housing 20. Along the rear portion 50 and side portion 40 of the docking station housing are disposed a plurality of peripheral ports, including various electrical jacks, connectors, and ports for direct connection of laptop accessories thereto without connection to the physical laptop. This facilitates ready removal and connection of the laptop to the peripheral items without removing or connecting the plugs of the peripheral items thereto. These can remain in contact with the docking station 20 while the laptop is operably connected to the docking station connection 31 when desired by the user.

Ideally the docking station supports connections for several Universal Serial Bus (USB) plugs, video connectors such as Video Graphics Array (VGA) and High-Definition Multimedia Interface (HDMI), audio input and output connectors (speakers/microphone connections), a power port for powering the docking station 20 and cooling platform 11, and even computer storage connections such as Secure Digital (SD) cards and the like. In this way, the docking station 20 operates as a means to support peripheral connections without physically connecting the same to the laptop itself. This improves the owner's ability to operably remove the laptop and use independently without tending to several wired connections.

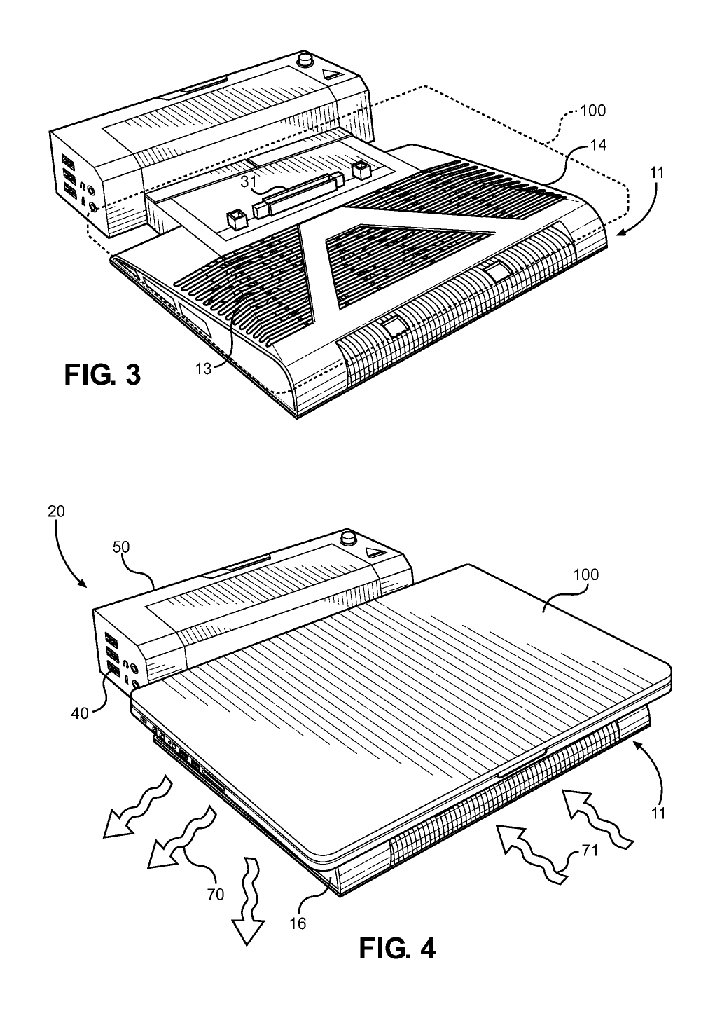

Referring now to FIGS. 2 and 3, there are shown views of the present invention from an overhead view and in a working state while supporting a laptop computer 100. The cooling platform 11 comprises an upper surface 15 having a plurality of apertures 14 therealong, through which heated air from the laptop is drawn into the cooling platform 11 interior and expelled through the sidewalls 16. Preferably, three high efficiency and high air flow fans 13 are situated within the platform 11 below the apertures 14 to actively draw air therethrough. As the laptop 100 is in operation and connected 31 to the device, the heat is generated from the laptop through electrical resistance and computational cycling. The fans 13 create airflow through the laptop to remove heated air and lower the air pressure below the laptop for improved cooling and improved operation of the computer's own fans.

Referring finally to FIG. 4, there is shown a view of the air flow through the device while the laptop cooling and docking station is in operation. While in operation, the cooling fans create an airflow that draws air from the above the cooling platform 11 and expels it through the sidewalls 16. The sidewalls 16 include apertures that allow communication of heated air 70 therethrough, while the upper surface apertures draw in air from the laptop computer 100 and from the surrounding air 71. This prevents environment along the underside of the laptop 100 from becoming stagnant and rising in temperature, which would stifle heat dissipation from the laptop. While the cooling fans operate, the laptop 100 is can connect to the docking station 20 by way of the SCSI connector, allowing for peripheral connections along the sides 40 and rear 50 of the docking station housing 20.

Laptop computers generate considerable heat during operation, especially high-powered laptop devices that undergo millions of cycles per second and drive high end hardware. After prolonged use or during periods of peak usage, heat generation can reach its peak. Onboard fans and heat sinks draw heat away from the laptop processor and electrical components, however this heat dissipation may not be sufficient to overcome overheating if the computer is working at peak capacity and the environment is not suited to draw the heated air away from the computer.

The present invention provides a ready solution to this known issue by facilitating air removal from the laptop, while at the same time expanding the laptop peripheral connectivity at the same time. The device includes high efficiency and high air flow fans that operate to cool the laptop computer while it is docked, while electrical connectivity is afforded to enable a user to use his or her laptop with several peripheral items, such as a keyboard or monitor, while keeping the device running at a cool temperature. The device provides users with an easy way to prevent their laptops from overheating while being used with an external monitor, keyboard, mouse or other accessories. The device may be most useful to IT professionals in the workplace, or anyone who wants to hook up his or her laptop to a docking station at home.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A laptop computer cooling and docking station, comprising:
a cooling platform, a docking station peripheral housing, and a bridge therebetween;
said cooling platform comprising a substantially rectangular housing having an upper surface, an interior, and upstanding sidewalls;
said upper surface being adapted to support a thereon;
said upper surface and said sidewalls having a plurality of apertures disposed therethrough;
at least one electrical cooling fan within said cooling platform interior, said cooling fan adapted to draw air through said upper surface apertures and expel air through said sidewall apertures;
said docking station peripheral housing supporting a plurality of computer peripheral ports and electrical connectivity therefor;
an electrical connection adapted to connect an attached laptop to said docking station peripheral housing peripheral ports.

2. The device of claim 1, wherein said at least one cooling fan comprises three cooling fans.

3. The device of claim 1, wherein said electronic interface comprises a SCSI connection.
